(19) United States
(12) Patent Application Publication
(10) Pub. No.: US 2023/0326225 A1
(43) Pub. Date: Oct. 12, 2023

(54) SYSTEM AND METHOD FOR MACHINE LEARNING DOCUMENT PARTITIONING

(71) Applicant: Thomson Reuters Enterprise Centre GmbH, Zug (CH)

(72) Inventor: Joel M. HRON, II, The Woodlands, TX (US)

(21) Appl. No.: 18/130,656

(22) Filed: Apr. 4, 2023

Related U.S. Application Data
(60) Provisional application No. 63/329,154, filed on Apr. 8, 2022.

(51) Int. Cl. G06V 30/416; G06V 30/14; G06V 10/764

(52) U.S. Cl. CPC G06V 30/416; G06V 30/1456; G06V 10/765

(57) ABSTRACT

Aspects of the present disclosure involve systems and methods for an automated machine learning partitioning of a digital image file into multiple documents. The machine learning system may obtain or receive a digital image file that includes multiple documents merged into the single image file. To determine the different documents included in the image file, the machine learning model may analyze the content of the pages of the image file to determine particular content that may indicate the start and/or end of documents within the image file and partition the image file into multiple documents based on the determined start and/or end of the documents. In one instance, the machine learning partitioning system may generate an analysis window that comprises two pages of the corpus of pages and compare features or content of the two pages or determine if either of the two pages includes one or more features.

### CROSS-REFERENCE TO RELATED APPLICATION

This application is related to and claims priority under 35 U.S.C. § 119(e) from U.S. Patent Application No. 63/329,154 filed Apr. 8, 2022 entitled “System and Method for Machine Learning Document Partitioning”, the entire contents of which is incorporated herein by reference for all purposes.

### TECHNICAL FIELD

The present disclosure relates to processing of documents, and in particular, to utilizing a machine learning or artificial intelligence machine to identify document partitions in a document image file.

### BACKGROUND

In nearly any relatively large organization, whether it be a corporate organization, governmental organization, educational organization, etc., document management is important but very challenging for a myriad of reasons. To begin, in many organizations the sheer number of electronic documents is challenging. In many situations, organizations employ document management systems and related databases that may provide tools to organize documents. However, in many digital document systems today, the starting point for the document is actual a “file” is not guaranteed to represent a “document”, in the sense of the word that may businesses intend it to. For example, many document scanning processes today involve the scanning of boxes of paper files into digital form, a process by which many related documents may be merged together into a single file (i.e., an image file such as a .pdf). Thus, the base files for document management services may include files that include several documents grouped together as related to the same or similar topic, deal, agreement, etc. This is not ideal for most digital systems because the underlying documents within the file remain unknown and undiscoverable.

In some instances, humans may be involved in inspecting each of the pages of the documents being scanned and separating the documents contained within the box into discrete documents. This additional human labor in the scanning process, however, adds significant cost and time to the process. Overall, whether at creation or during a later procurement, organizations often expend great resources reviewing and/or storing documents so that that those documents can be processed in a meaningful manner by the organization.

It is with these observations in mind, among others, that aspects of the present disclosure were conceived.

### SUMMARY

Embodiments of the disclosure concern document management systems and methods. A first embodiment includes a method for management of electronic files. The method may include the operations of accessing, by a processor and from a database of a plurality of electronic documents, an electronic image file, extracting, by a trained machine learning model, one or more text features from the image file indicative of a partition between a first document and a second document within the image file, and determining, by the trained machine learning model and based on the extracted one or more text features, a document partition location within the image file. The method may also include the operations of receiving feedback data corresponding to an accuracy of the determined document partition location within the image file and adjusting, based on the feedback data, a parameter of the trained machine learning model.

Another embodiment may include a system for management of electronic files. The system may include a processor and a memory comprising instructions. When the instructions are executed, the processor may access, from a database of a plurality of electronic documents, an electronic image file, extract, by a trained machine learning model, one or more text features from the image file, each of the one or more text features indicative of a partition between a first document and a second document within the image file, and locate, by the trained machine learning model and based on the extracted one or more text features, a document partition location within the image file. The processor may further receive feedback data corresponding to an accuracy of the determined document partition location within the image file and adjust, based on the feedback data, a parameter of the trained machine learning model.

Yet another embodiment may include one or more non-transitory computer-readable storage media storing computer-executable instructions for performing a computer process on a computing system. The computer process may include the operations of accessing, by a processor and from a database of a plurality of electronic documents, an electronic image file, extracting, by a trained machine learning model, one or more text features from the image file indicative of a partition between a first document and a second document within the image file, and determining, by the trained machine learning model and based on the extracted one or more text features, a document partition location within the image file. The computer process may also include the operations of receiving feedback data corresponding to an accuracy of the determined document partition location within the image file and adjusting, based on the feedback data, a parameter of the trained machine learning model.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a system diagram for a document management system for automatically partitioning a digital image file into multiple documents contained within the image file, in accordance with various embodiments.

FIG. 2 illustrates a flowchart of a method for utilizing a machine learning system to partition a digital image file into multiple documents based on the content of the image file, in accordance with various embodiments.

FIG. 3 is an illustration of a partitioning of a digital image file into multiple documents, in accordance with various embodiments.

FIG. 4 illustrates a flowchart of a method for analyzing a digital image file to locate one or more document partitions based on the content of the image file, in accordance with various embodiments.

FIG. 5 is an example screenshot of a display of a partitioned image file into multiple documents, in accordance with various embodiments.

FIG. 6 is a system diagram for adjusting a machine learning document partitioning model based on feedback data associated with one or more outputs of the model, in accordance with various embodiments.

FIG. 7 is a system diagram of an example computing system that may implement various systems and methods discussed herein, in accordance with various embodiments.

### DETAILED DESCRIPTION

Aspects of the present disclosure involve systems and methods for an automated machine learning partitioning of a digital image file into multiple documents. The machine learning system may, in some implementations, obtain or receive a digital image file that includes multiple documents merged into the single image file. The multiple documents may be related or correspond in any manner, including documents related to the same deal or agreement, documents generated by the same sender, documents included in the same database or storage location, documents associated with a legal proceeding, and the like. In some instances, the documents may not be related by subject, but may nonetheless be included in the same digital image file. To determine the different documents included in the image file, the machine learning model may analyze the content of the pages of the image file to determine particular content that may indicate the start and/or end of documents within the image file and partition the image file into multiple documents based on the determined start and/or end of the documents.

In some instances, the machine learning model may first convert the image file to text through one or more text extraction mechanisms to begin the partitioning process. For example, the model may utilize an Optical Character Recognition (“OCR”) technique to convert the content of the image file into text. The extracted text from the image file may generate an initial corpus of pages of text for analysis to determine one or more partitions within the image file indicating different documents. The analysis of the corpus may take many forms. In one instance, the machine learning partitioning system may generate an analysis window that comprises two pages of the corpus of pages and compare features or content of the two pages or determine if either of the two pages includes one or more features. For example, the machine learning partitioning system may determine whether either page includes content indicating a title, whether either page includes a page number, whether either page includes a page number with the value of “1”, whether the page contains a signature block or digital signature, and the like. For comparison of the two pages, the machine learning partitioning system may determine a value of a page number included in each page and determine if the page numbers are sequential. In another example, the machine learning partitioning system may determine if a page layout is consistent or similar between the two pages, such as the same or similar header, footer, margins, font size, etc. Any combination of these features or other features from the two pages may be analyzed by the machine learning partitioning system. In other instances, the analysis window may be of any number of pages or a portion of a single page.

Based on an analysis of the features of the page or pages in the analysis window, a determination that the first page of the window indicates a last page or ending of a document and that the second page of the window indicates a first page or beginning of another document may be made. For example, the first page of the analysis window may include a signature block and the second page may include a title. In another example, the first page may include a page number value greater than one and the second page may include a page number value of one. In still another example, the first page may include formatting features, such as footer information including a document number value, and the second page may include different formatting features, such as footer information including no document number value. Other features of the analyzed pages may also be used to determine the two pages indicate a partition from a first document of the image file to a second document of the image file. The machine learning partitioning system may, in response to the determined features, generate a partition indicator between the two analyzed pages. The generated partition indicator may, in some examples, be inserted into or otherwise correspond with the image file and/or the corpus of document pages. In one particular example, a dividing line between the determined documents of the image file may be inserted into the image file by the partitioning system. Other indicators of a separation of documents within the image file or otherwise associated with the image file are also contemplated. As explained in more detail below, the partition indicator may be used to train the machine learning partitioning system and/or may be displayed on a display device.

The machine learning partitioning system may continue the analysis discussed above for each extracted page of the image file. For example, the analysis window may roll to include the next page in the corpus such that the first page in the rolled window is the last page of the window of the previous analysis. In this manner, each page may be compared to the previous page and the following page in the corpus. The machine learning partitioning system may roll the analysis window through each page of the image file until the last extracted page is analyzed. Upon analysis of each page of the image file, one or more partition indicators may be generated that correspond to the determined transitions from one document to the next within the image file. Such information may be provided to one or more systems, such as a user device on which the partition indicators may be displayed. In one implementation, the partition indicators may be displayed as occurring between page numbers of the image file. In another implementation, a user interface may display a thumbnail or other representation of each page of the image file, with partition indicators displayed between the thumbnails of pages for which a document transition was determined above. In yet another implementation, the partition indicator information may be provided to the machine learning partitioning system for use in training the machine learning partitioning system. The partition indicator information may be provided in any data format. In this manner, the different documents in a digital image file may be determined automatically by the machine learning partitioning system.

As mentioned above, the machine learning partitioning system may be trained using digital image files to improve the accuracy of the identification of the various documents of the files. In one implementation, training data may be generated comprising an image file with known separation between documents included in the image file. The image file may then be analyzed by the machine learning partitioning system to detect the partition between the documents of the image file. A correct or incorrect result of the identification of the partition between the documents of the image file may then be determined and used to train the machine learning partitioning system. For example, an incorrect partition identification may cause the machine learning partitioning system to adjust one or more parameters or characteristics of the machine learning partitioning model to improve the accuracy of the partition identification. A correct partition identification may cause a similar action, causing the machine learning partitioning system to reinforce a correct analysis of the content of the documents of the image file. For example, training of the machine learning partitioning model may include adding or removing particular features of the content of the image file that are searched for to indicate a partition between documents of the file, adjusting one or more weights assigned to the particular features of the content of the image file, adjusting a combination of features of the content of the image file that are searched for, and the like. Through the training of the machine learning partitioning model, a more accurate and efficient identification of partitions of documents within a digital image file may be obtained for use in analyzing and/or storing the documents with a document management platform. These and other advantages may be obtained through the machine learning partitioning system described herein.

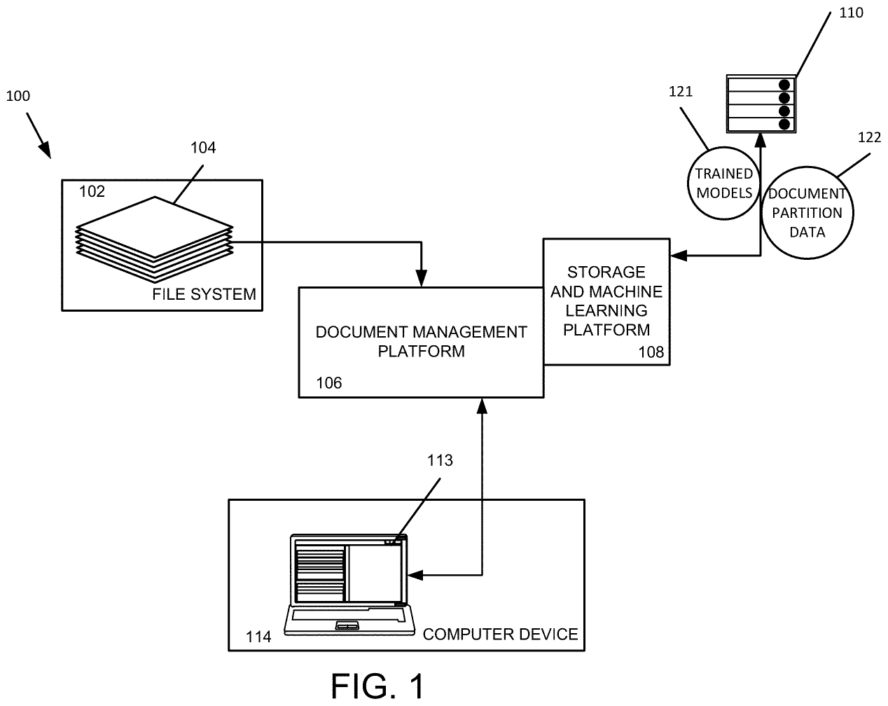

FIG. 1 depicts one example of a document management system 100 for automated machine learning partitioning of a digital image file into multiple documents. The system 100 may receive or otherwise gain access to one or more electronic image files 104 through a file system 102, a database, and the like. The system 100 described herein may be used with any type of image file stored in any type of storage device 102. Further, each image file 104 may comprise multiple documents that are combined into a single image file. For example, an image file 104 may include several documents that each pertain to a contract between two or more parties. To reduce the number of documents accessed to understand the terms of the contract, all of the documents for the contract may be combined into a single image file 104. It should be recognized that, when first loaded to or accessed by the system 100, the image file 104 may be of any form (e.g., PDF, JPG, PNG, etc.) from which the system may extract text or other features of the content of the image. In some embodiments, the system may receive one or more images of, for example, documents corresponding to a contract. Text extraction (and other features of the content of the image data such as margin spacing, footer and/or header information, page numbers, etc.) can be done by various tools available on the market today falling within the broad stable of Optical Character Recognition (“OCR”) software.

In the example illustrated, the digital image file 104 may be stored in a system database 102 or other memory provided by a machine learning services platform 108 as a remote device 110, although a local storage of the image files may also be incorporated. The database 102 can be a relational or non-relational database, and it will be apparent to a person having ordinary skill in the art which type of database to use or whether to use a mix of the two. In some other embodiments, the image file 104 may be stored in a short-term memory rather than a database or be otherwise stored in some other form of memory structure. Image files 104 stored in the system database may be used later for training new machine learning models and/or continued training of existing machine learning models 121

A document management platform 106 may communicate with and access one or more documents 104 from the database 102 to automate a machine learning model for partitioning an image file into one or more documents or otherwise indicating a partition between documents of the image file. In general, the document management platform 106 can be a computing device embodied in a cloud platform, locally hosted, locally hosted in a distributed enterprise environment, distributed, combinations of the same, and otherwise available in different forms. In one particular implementation, the document management platform 106 may analyze the contents of an image file 104 for particular characteristics or features and associate one or more document partition indicators with the image file. The document partition indicators may be determined by a machine learning partitioning model which may be trained by the machine learning platform 108 and stored as a trained model 121. In some instances, the storage and machine learning platform 108 may store the document partition data 122 as associated with the image files 104, as discussed in more detail below. In still additional implementations, a computing device 114 may communicate with the document management platform 106 to receive the image file 104 and/or the document partition data 122 for display in a graphical user interface 113. The user interface 113 may also be utilized to control or alter aspects of the document partitioning model 121.

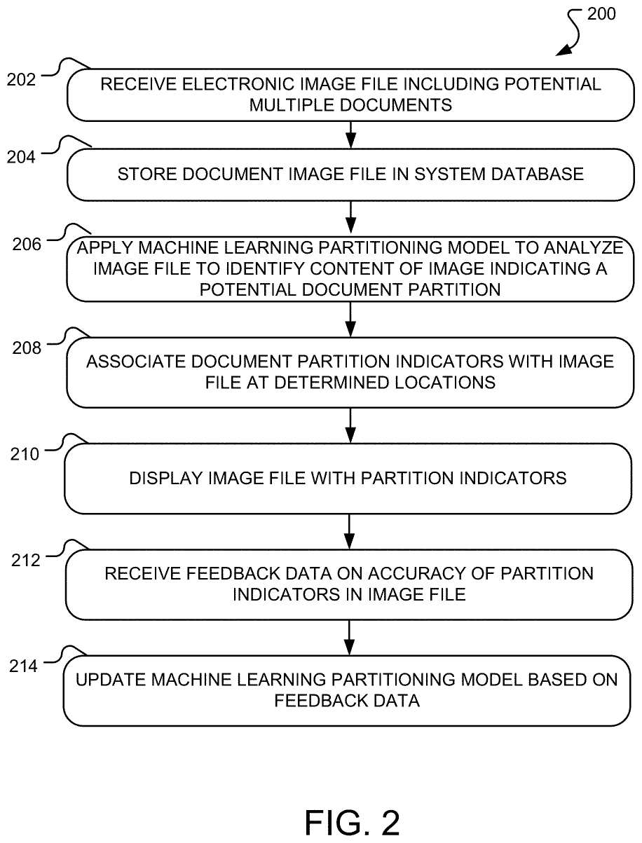

FIG. 2 illustrate a illustrates a flowchart of a method 200 for utilizing a machine learning system to partition a digital image file 104 into multiple documents based on the content of the image file, in accordance with various embodiments. As such, the steps of the method 200 may be executed by the document management platform 106, the storage and machine learning platform 108, the computing device 114 on which the user interface 113 is executed, or a combination of any of the above. Through the method 200, one or more document partitions may be associated with an image file corresponding to two or more documents included in the image file. In addition, the document partitions may be determined by a machine learning partition model that is trained using image files with known document partitions and/or feedback data corresponding to determine partitions associated with various image files.

Beginning at step 202, the machine learning system may receive one or more electronic or digital image files that include one or more potential documents within the file. In one example, an image file may comprise or be related to a legal proceeding, such as a contract between two or more parties, a contract defining a business deal, and the like, and may include multiple documents related to the proceeding. For a contract, the image file 104 may include an initial agreement document, one or more amendments to the agreement, exhibits, signature pages, and the like. In general, the image file 104 may include any number and type of documents. More particularly, the image file 104 may include any number of images of the pages of several documents from which the text of the documents may be extracted, perhaps through an OCR technique. The image file 104 may be any type of computer file from which text may be determined or analyzed. At step 204, the image file 104 may be stored in a system database, such as remote database 110 or local storage of the document management platform 106.

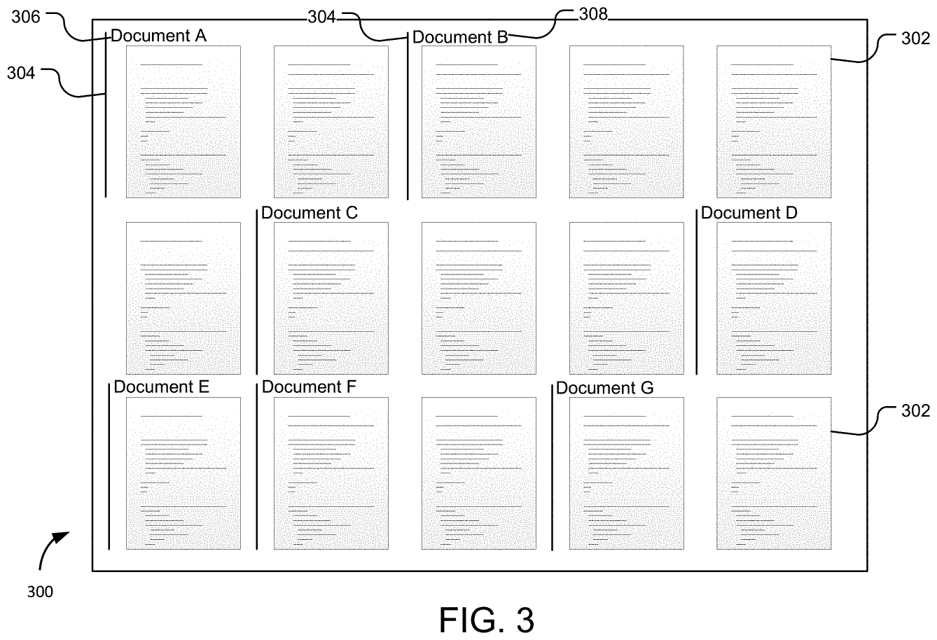

At step 206, the machine learning partitioning model may analyze the image file to identify content of the image that may indicate a partition between documents of the image file. FIG. 3 is an illustration 300 of a partitioning of a digital image file into multiple documents, in accordance with various embodiments. In particular, the illustration 300 shows the multiple pages 302 of the image file. One or more of the pages 302 of the image file may correspond to a document within the image file. For example, the image file may include a first document including terms and conditions for a contract, a second document including an amendment to the contract, a third document including exhibits related to the contract, and the like. Thus, even though a single image file may be analyzed, several documents may be included in the image file. However, the separation between the documents within the image file may not be initially known by the document management platform 106. Rather, the documents of the image file may be included contiguously within the pages of the image file without identifying markers or indicators of the separation between the documents.

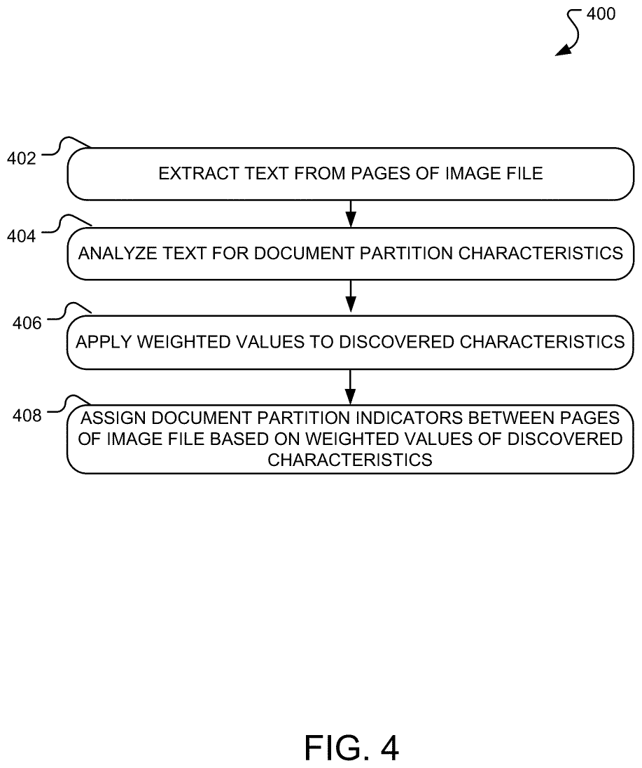

The machine learning partitioning model may perform one or more of the steps of the method 400 illustrated in FIG. 4 to analyze the digital image file to locate the one or more document partitions based on the content of the image file. In particular and starting at step 402, the machine learning partitioning model may first extract the text from the image pages of the file. For example, the machine learning partitioning model may convert each page into text using some text extraction technique, such as an OCR technique. Other text extraction and/or image file analysis techniques may be executed.

Upon extraction, the machine learning partitioning model may analyze the features or characteristics of the extracted text for indicators of the beginning of a document or an end of a document at step 404. For example, the machine learning partitioning model may determine whether the extracted text for an analyzed page includes content such as a title, a page number, the value of the page number, a signature block or digital signature, and the like. In general, any characteristic of feature of the extracted text may be indicate either the beginning of a document or an end of a document. As explained above, the machine learning partitioning model may analyze the extracted text of two sequential pages to determine the beginning of a document or an end of a document. For example, the machine learning partitioning model may determine a value of a page number included in each page and determine if the page numbers are sequential. However, if the page numbers of the analyzed pages are not sequential, the numbers may indicate different documents. In another example, the machine learning partitioning system may determine if a page layout is consistent or similar between the two pages, such as the same or similar header, footer, margins, font size, etc. Any combination of these features or other features from the two pages may be analyzed by the machine learning partitioning system.

At step 406, the machine learning partitioning model may apply one or more weighted values to the characteristics or features determined in the extracted text. For example, the machine learning partitioning model may be configured to assign a higher weight to certain characteristics, such as a title or a signature block, then to other characteristics, such as margin spacing or footer information. The weighted values may cause the machine learning partitioning model to value certain characteristics of the extracted text over other characteristics. In some instances, the weighted value may cause the machine learning partitioning model to dismiss some determined characteristics.

At step 408, the machine learning partitioning model may assign one or more document partition indicators between pages of the image file based on the determined characteristics and the weighted values assigned to those determined characteristics. The document partition indicators assigned to the image file may take many forms. For example, metadata associated with the image file 104 may be amended or altered to include an indication of a document partition. Such information may include a beginning or ending page number of the image file associated with an identified document and, in some instances, an identifier of the document, such as “Document A”, a document title obtained or determined from the content of the image file pages, a document number either generated or obtained from the image file content, and the like. In another example, the content of the image file itself may be altered with the document partition indicator inserted between the identified pages of different documents. In still another example, the document partition indicators for an image file may be stored separately from the image file with a pointer to the image file or otherwise associated with the image file such that the partition indicator or other partition information may be obtained for the given image file.

Returning to the method 200 of FIG. 2, the document partition indicators determined above may be associated with the image file at step 208. As mentioned, associating the partition indicators may include altering some aspect of the image file, such as metadata of the file, or storing the document partition information or data separate from the image file. In the example system illustrated in FIG. 1, the document partition data 122 may be stored separately from the image file by the storage and machine learning platform 108. The document partition data 122 may include pointers or other references to one or more image files 104 such that the document partition data for a particular image file may be requested and obtained or otherwise accessed by the document management platform 106.

At step 210, the image file 104 may be displayed on a display device along with the one or more document partitions. For example, the document management platform 106 may transmit the image file 104 to the computer device 114 for display on the user interface 113 executed by the computer device. Through the user interface 113, the content of the image file may be displayed, such as that illustrated in the image 300 of FIG. 3. More particularly, the different pages 302 of the image file 104 may be displayed on the user interface 113, in some instances in response to a request to display the image file received via the user interface. In addition to transmitting the image file 104, the document management platform 106 may also obtain and/or transmit document partition data 122 associated with the image file to the computer device 114. The document partitioning data 122 for the selected image file 104 may also be displayed on the user interface 300. In the example illustrated in FIG. 3, dividing or partitioning lines may be inserted into the user interface 300 between pages to indicate the end of a document and/or the beginning of a document. In particular, a vertical line 304 may be illustrated in the user interface 300 at the beginning of each document determined within the image file to indicate a partition between detected documents. Pages of the image file to the right of the partition line 304 in the same row and continuing to the leftmost page in the next row may belong to a single document, until another partition line is shown. In addition, one or more of the partition lines 304 may be associated with a document name, title, number, or any other document-specific indicator 306. For example, the first detected document of the image file 104 may be labeled as “Document A”, a second document may be labeled “Document B” 308, and so on. It should be understood that the example illustrated in FIG. 3 is but one way to display the document partition information or data associated with an image file and many alternatives to the images displayed in the user interface 300 are similarly contemplated.

Through the user interface 113 executed on the computer device 114, a user or system may view the pages or other content of the image file 104 and the determined partitions between documents included in the image file. This determination of the partitions or separations between the documents included in the image file 104 may occur automatically, without input from the user as to the location of the document partitions. Thus, the machine learning partitioning system described herein may determine and/or present partitions between the documents of the image file 104 based on the content of the extracted text from the file.

The machine learning document partitioning system 100 may be updated or revised based on feedback on the accuracy or success of the determined document partitions. In particular, the machine learning document partitioning system may determine one or more partitions of documents within one or more image files. The partitions within the one or more image files may be analyzed and a correct identification or an incorrect identification of each of the partitions may be determined and associated with each of the partitions. Using the example illustrated in FIG. 3, the determine partition 304 indicated as the beginning of Document B 308 may be analyzed to determine if Document B begins at that page within the image file such that the partition indicator is correctly located between Document A 306 and Document B. If correct, a successful identification of the document partition may be generated for that partition. If incorrect, an unsuccessful identification of the document partition may be generated for that partition. This correct/incorrect determination for each partition may be associated with the image file and provided to the machine learning document partitioning system at step 212.

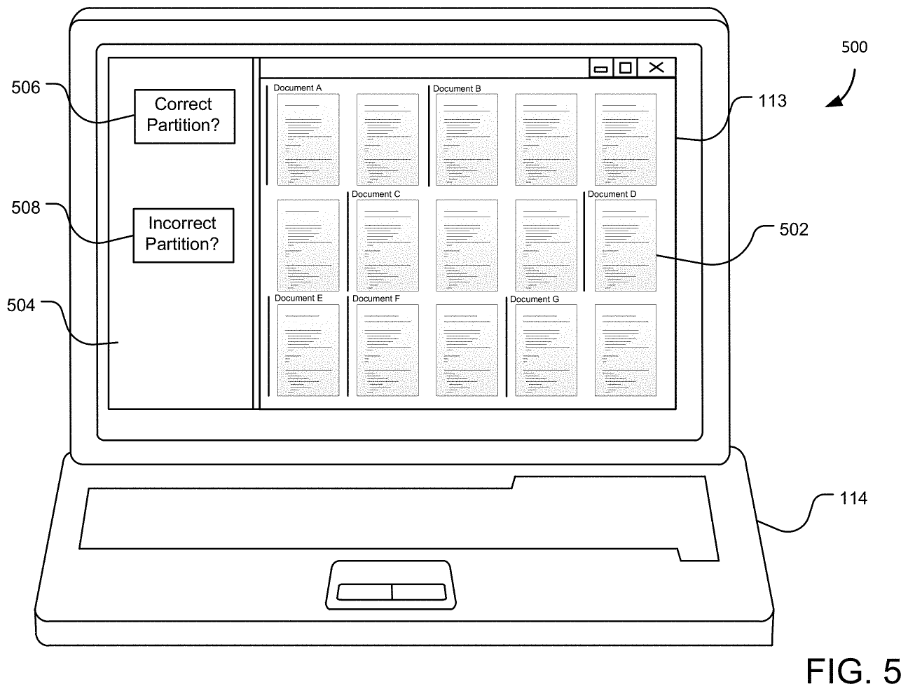

The feedback data may take many forms and may be generated by a system or by a user of the machine learning document partitioning system. For example, a user may analyze the generated partitions 304 for a given image file 104 and select correct or incorrect indicator for each partition. FIG. 5 is an example screenshot 500 of a display of a partitioned image file into multiple documents through which a user may provide feedback to the machine learning document partitioning system. The screenshot 500 is one example of the user interface 113 illustrated on the computer device 114. The user interface 113 may include a first panel 502 similar to that described above with reference to FIG. 3 in which the pages of a selected image file is illustrated along with one or more document partition indicators. The user interface 113 may also include a second panel 504 through which feedback on the accuracy of determined document partitions may be provided. In one implementation, the second panel 504 may include a first activation button 506 that, when selected, indicates a correct identification of a document partition within the image file. The second panel 504 may also include a second activation button 508 that, when selected, indicates an incorrect identification of a document partition within the image file. A user of the interface 113 may therefore utilize an input device, such as a mouse or a keyboard, to select a partition indicator within the first panel 502 and select that the indicator is correct through activation of button 506 or incorrect through activation of button 508. The selection through the activation buttons 506, 508 may be transmitted or otherwise provided to the machine learning document partitioning system.

In another example, a system may determine the correct or incorrect identification of the documents within an image file as determined machine learning document partitioning system. For example, the image file may comprise training data that includes files with prior identified partition locations at the places in the image file between documents. This image file may then be analyzed by the machine learning document partitioning system to identify the document partition locations within the file. Upon the identification of the partitions, the machine learning document partitioning system may compare the known document partitions within the image file to the determined partitions to determine if the partitions are successful or unsuccessful. This type of training image file may be automatically generated through a synthetic generation of stitching together known documents into one or more image files and comparing the results of the machine learning document partitioning system identifying the document partitions. The training of the machine learning document partitioning system using training image files may occur any number of times to refine the machine learning document partitioning model for more accuracy, as described in more detail below.

At step 214, the machine learning document partitioning model may be updated or adjusted based on the feedback data provided to the machine learning document partitioning system. For example, the machine learning document partitioning model may be configured to detect particular characteristics of the text extracted from the image file when determining a document partition within the image file. Some models may detect one particular characteristic or a combination of characteristics. The types of characteristics used to determine a document partition may be adjusted based on the feedback data received by the machine learning document partitioning system. For example, the machine learning document partitioning model may determine a document partition is detected within the image file based on a detection of a signature block on a page of the image file, followed by a title located on the next page. However, the feedback data may indicate that the document partition was incorrect as the title may be a section heading of the signature block may occur on several pages within a document. Based on this feedback information, the machine learning document partitioning model may be adjusted to detect different characteristics, such as page numbers, document identifiers within the extracted text, margin features, etc. instead of or in addition to the signature block and title. Through multiple iterations of training, particular features of the extracted text may be identified as the most successful in identifying a document partition within the image file.

In another example, one or more weighted values applied to or otherwise associated with the various text characteristics may be adjusted based on the feedback data. In particular, the machine learning document partitioning model may weigh certain extracted text features more heavily than others as being more indicative of a partition between documents within the image file. For example, a page number value of “1” may be have a larger weighting value than a difference in margin spacing from one page to the next. In general, the weighted values may take any form, such as an integer value between 0-100. In some instances, weighted values may be received via the user interface 113 executed on the computer device 114. Further, the weighted values may be adjusted by the machine learning document partitioning system based on the feedback data provided to the system in response to an output of the machine learning document partitioning model. For example, a particular combination of features of extracted text may be noted as correct or accurately determining the document partitions within an image file and the machine learning document partitioning model may be updated to increase the weighted value associated with those features. Similarly, an incorrect document partition determination based on one or more particular features may cause the machine learning document partitioning system to adjust the weighted values of the document partitioning model lower in response to the feedback data that the determined partition was incorrect. In general, any aspect of or process of the machine learning document partitioning model may be adjusted in response to the feedback data.

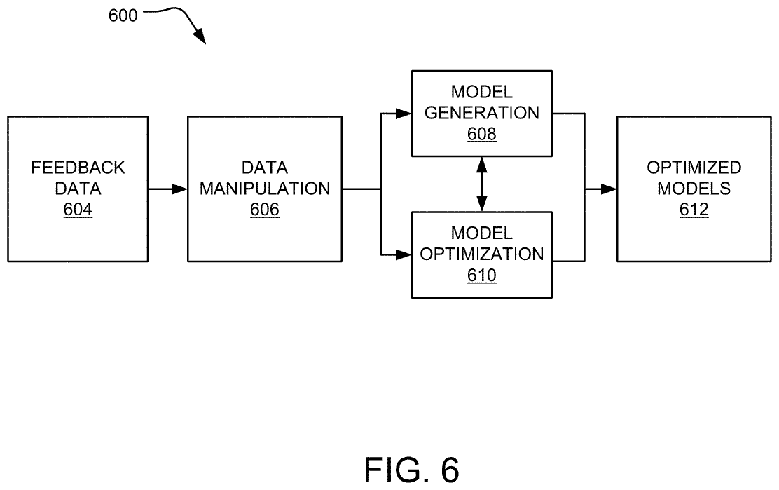

FIG. 6 is a block diagram illustrating an example data flow 600 for adjusting a machine learning document partitioning model based on feedback data associated with one or more outputs of the model. Through the data flow 600 of FIG. 6, an optimized document partitioning model may be generated incorporating feedback data, resulting in more accurate document partition identification models. In one particular implementation, the steps outlined in the data flow 600 of FIG. 6 may be executed by the document management platform 106 automatically or in response to feedback data provided through a user interface to generate an optimized document partitioning model. In other instances, however, any component of the system 100 of FIG. 1 or any other computing device in communication with one or more of the components of the network environment may execute one or more applications to generate the data flow 600.

The data flow 600 may include receiving or accessing feedback data 604 as an input to a machine learning system. In some instances, the feedback data 604 may be accessed from a database. As described above, the feedback data 604 may include an indication of correct or incorrect identification of a document partition within any number of image files and may be generated from an analysis of an output of the document partitioning model or via the user interface 113. Additional data may also be included in the feedback data 604, such as feedback data from other document partitioning models, known document partitions of image files used to train one or more models, image file metadata, user inputs from the user interface 113, location data within an image file of a determined document partition, an error value for a determined document partition (such as a number of pages between a determined document partition within the image file and the actual document partition), and the like. In general, the number and types of feedback data 604 may vary such that no particular type or size of feedback data is required to generate an optimized document partitioning model. Rather, any datasets or portions of available feedback information may be supplied as input to the data flow, although additional data may result in a more detailed optimized document partitioning model.

The received or accessed feedback data 604 may be manipulated to generate a dataset for input into one or more document partitioning models. For example, the feedback data from the various sources (databases, user interfaces, other models, etc.) may be processed to be integrated together into a data package for use by the document partition system to adjust or tune a particular document partitioning model. In one example, various forms of feedback data, such as feedback received from a user interface and feedback from a system, may be combined into a common format for processing by the document partitioning system. In this manner, the manipulated data 606 may be used as inputs to the document partitioning models and may include different sources of feedback data and information.

The input dataset 606 may be used to build or alter one or more document partitioning models 608. In some instances, multiple models may be generated through different modeling methodologies. In some instances, the modeling methodologies may include deep thinking and/or machine learning techniques and may, in some implementations, be performed by one or more computing devices in communication and operating in parallel. Multiple document partitioning models 608 may be generated with different partition identifying characteristics. For example, a first document partitioning model may include a first set of weighted values corresponding to a first set of extracted text characteristics while a second document partitioning model may include a second set of weighted values corresponding to a second set of extracted text characteristics, with some or all of the weighted values and text characteristics being different between the sets. Other models may include different sets of weighted values and extracted text characteristics associated with those weighted values.

The generated models 608 may be optimized or adjusted based on the manipulated feedback data 606 to generate one or more optimized document partitioning models 612 as an output of the data flow 600. For example, one or more parameters of a document partitioning model may be adjusted based on the feedback data as discussed above. Other generated models may also be adjusted based on the same or different feedback data. Also, the process of generating and optimizing a model may occur many times as models are generated or adjusted in response to feedback data, analyzed for accuracy, and adjusted further. This iterative process may continue any number of times to generate the optimized document partitioning model 612 for identifying document partitions in one or more image files. The document management platform 106 may utilize the optimized machine learning document partitioning model 612 to identify document partitions within one or more image files 104, as described above.

As mentioned, more than one machine learning document partitioning model may be generated and adjusted through the systems and processes described herein. In some instances, a first document partitioning model may correspond to a first collection of image files 104 and a second document partitioning model may correspond to a second collection of image files. For example, the set of image files of contracts or other legal documents may be associated with a client or user of the document management platform 106. To determine the document partitions within the image files for the user, a document partitioning model may be trained using image files of the user or other legal document type image files. Another user may be associated with a different type of image files, such as leases, purchase orders, and the like and a document partitioning model may be trained using image files similar to the image files for that user. In still another example, image files for a particular user may include reports and readouts of data from a monitored system. A document partitioning model may be trained using similar image files that include readouts from the monitored system or a similar system. In this manner, one or more users or clients of the document management platform 106 may be associated with a single or shared document partitioning model that is trained with image files similar to the image files associated with the particular user of the platform.

In some instances, a global document partitioning model may be trained and provided through the document management platform 106 to any number of users of clients. This global document partitioning model may be updated and adjusted based on feedback data received from one or more of the clients to the document management platform 106. In another instance, the global document partitioning model may be a base model from which individualized document partitioning models may be generated. For example, a client of the document management platform 106 may receive a document partitioning model trained from feedback data received at the platform from other users. This global partitioning model may then be further refined and trained based on image files associated with the client to improve the accuracy of the partitioning model for the user's specific types of image files or documents. The feedback data generated during the training portion of the user-specific document partitioning model may or may not be provided to train the global document partitioning model. In this manner, one or more local document partitioning models may be generated and trained using local image files in addition to a global document partitioning model trained using generic image files or specific image files of one or more clients or users.

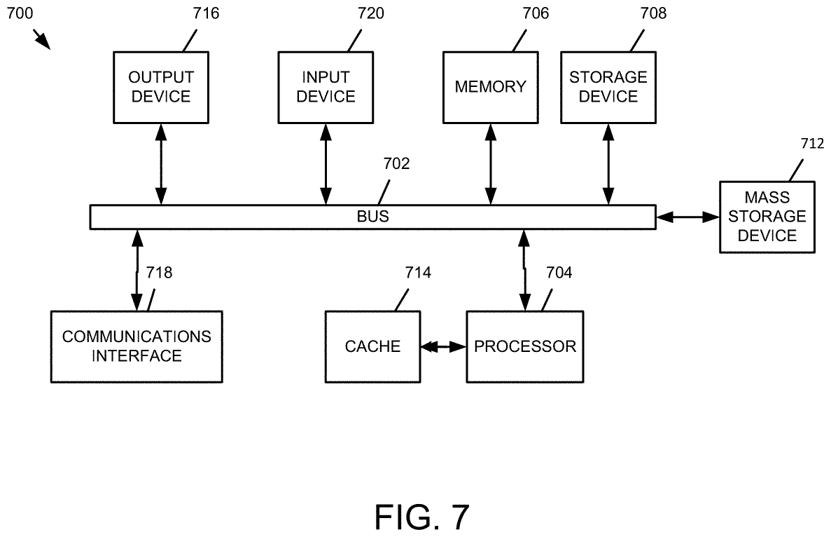

FIG. 7 an example computing system 700 that may implement various systems and methods discussed herein. The computer system 700 includes one or more computing components in communication via a bus 702. In one implementation, the computing system 700 includes one or more processors 704. The processor 704 can include one or more internal levels of cache (not depicted) and a bus controller or bus interface unit to direct interaction with the bus 702. Main memory 706 may include one or more memory cards and a control circuit (not depicted), or other forms of removable memory, and may store various software applications including computer executable instructions, that when run on the processor 704, implement the methods and systems set out herein. Other forms of memory, such as a storage device 708 and a mass storage device 712, may also be included and accessible, by the processor (or processors) 704 via the bus 702. The storage device 708 and mass storage device 712 can each contain any or all of an electronic document.

The computer system 700 can further include a communications interface 718 by way of which the computer system 700 can connect to networks and receive data useful in executing the methods and system set out herein as well as transmitting information to other devices. The computer system 700 can include an output device 716 by which information is displayed, such as the display 300. The computer system 700 can also include an input device 720 by which information is input. Input device 720 can be a scanner, keyboard, and/or other input devices as will be apparent to a person of ordinary skill in the art. The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for management of electronic files, the method comprising:
accessing, by a processor and from a database of a plurality of electronic documents, an electronic image file;
extracting, by a trained machine learning model, one or more text features from the image file indicative of a partition between a first document and a second document within the image file;
determining, by the trained machine learning model and based on the extracted one or more text features, a document partition location within the image file;
receiving feedback data corresponding to an accuracy of the determined document partition location within the image file; and
adjusting, based on the feedback data, a parameter of the trained machine learning model.

2. The method of claim 1 wherein the extracted one or more text features comprise a page number, a title, a formatting feature, a signature block, or a document identifier of the image file.

3. The method of claim 1 wherein adjusting the parameter of the machine learning model comprises identifying a text feature different the one or more text features for extraction, adding a text feature different the one or more text features for extraction, or removing a text feature from the one or more text features.

4. The method of claim 1 further comprising:
associating a weighted value to the extracted one or more text features, wherein the determining the document partition location within the image file is further based on the weighted value.

5. The method of claim 4 wherein the adjusted parameter of the machine learning model comprises the associated weighted value to the extracted one or more text features.

6. The method of claim 1 wherein the document partition location within the image file comprises an indicator of a last page of a first document of the image file and a first page of a second document of the image file.

7. The method of claim 1 wherein extracting the one or more text features comprises executing an optical character recognition software.

8. The method of claim 1 further comprising:
generating, by the processor, a graphical user interface displaying at least a portion of a content of the image file and an indicator of the document partition location within the image file.

9. The method of claim 1 wherein the feedback data comprises a correct indicator or an incorrect indicator of the determined document partition location within the image file.

10. A system for management of electronic files, the system comprising:
a processor; and
a memory comprising instructions that, when executed, cause the processor to:
access, from a database of a plurality of electronic documents, an electronic image file;
extract, by a trained machine learning model, one or more text features from the image file, each of the one or more text features indicative of a partition between a first document and a second document within the image file;
locate, by the trained machine learning model and based on the extracted one or more text features, a document partition location within the image file;
receive feedback data corresponding to an accuracy of the document partition location within the image file; and
adjust, based on the feedback data, a parameter of the trained machine learning model.

11. The system of claim 10 wherein the extracted one or more text features comprise a page number, a title, a formatting feature, a signature block, or a document identifier of the image file.

12. The system of claim 10 wherein the processor is further caused to:
identify a text feature different the one or more text features for extraction, add a text feature different the one or more text features for extraction, or remove a text feature from the one or more text features.

13. The system of claim 10 wherein the processor is further caused to:
associate a weighted value to the extracted one or more text features, wherein the document partition location within the image file is further based on the weighted value.

14. The system of claim 13 wherein the adjusted parameter of the machine learning model comprises the associated weighted value to the extracted one or more text features.

15. The system of claim 10 wherein the document partition location within the image file comprises an indicator of a last page of a first document of the image file and a first page of a second document of the image file.

16. The system of claim 10 wherein the processor is further caused to:
generate a graphical user interface displaying at least a portion of a content of the image file and an indicator of the document partition location within the image file.

17. The system of claim 10 wherein the feedback data comprises a correct indicator or an incorrect indicator of the document partition location within the image file.

18. One or more non-transitory computer-readable storage media storing computer-executable instructions for performing a computer process on a computing system, the computer process comprising:
accessing, by a processor and from a database of a plurality of electronic documents, an electronic image file;
extracting, by a trained machine learning model, one or more text features from the image file indicative of a partition between a first document and a second document within the image file;
determining, by the trained machine learning model and based on the extracted one or more text features, a document partition location within the image file;
receiving feedback data corresponding to an accuracy of the determined document partition location within the image file; and
adjusting, based on the feedback data, a parameter of the trained machine learning model.

19. The one or more non-transitory computer-readable storage media of claim 18, wherein adjusting the parameter of the machine learning model comprises identifying a text feature different the one or more text features for extraction, adding a text feature different the one or more text features for extraction, or removing a text feature from the one or more text features.

20. The one or more non-transitory computer-readable storage media of claim 18, the computer process further comprising:
associating a weighted value to the extracted one or more text features, wherein the determining the document partition location within the image file is further based on the weighted value, wherein the adjusted parameter of the machine learning model comprises the associated weighted value to the extracted one or more text features.
